(19) United States
(12) Patent Application Publication
(10) Pub. No.: US 2019/0257108 A1
(43) Pub. Date: Aug. 22, 2019

(54) INSULATING AND STORM-RESISTANT PANELS

(71) Applicant: STORM STRONG LLC, Chicago, IL (US)

(72) Inventor: JERRY A CHERNEY, GLENVIEW, IL (US)

(21) Appl. No.: 15/777,879

(22) PCT Filed: Sep. 22, 2016
(86) PCT No.: PCT/US16/53184

§ 371 Date: May 21, 2018

Related U.S. Application Data
(60) Provisional application No. 62/221,979, filed on Sep. 22, 2015.

(51) Int. Cl. E04H 9/14; E04H 9/02; E04B 1/76; E04C 2/24; E04C 2/32; B32B 3/28; B32B 7/12

(52) U.S. Cl. CPC E04H 9/145; E04H 9/02; E04B 1/7604; E04C 2/243; E04C 2002/345; E04C 2/322; B32B 3/28; B32B 7/12; E04C 2/246

(57) ABSTRACT

In one example, the present invention is directed at a panel that includes (a) a first material having an inside surface and an outside surface, (b) a second material having an inside surface and an outside surface, (c) a zig-zag web with arms and apices disposed between the first material and the second material, (d) insulation disposed between adjacent arms, (e) a composite material comprising an adhesive and particulate material, wherein the composite material is applied to (i) inside surfaces of the first material and the second material, (ii) the zig-zag web, and (iii) the insulation; and wherein the outside surfaces of the first material and the second material are each substantially planar and parallel to one another, the inside surfaces of the first material and the second material contact the apices, and the first material and the second material are the same or different.

### BACKGROUND OF THE INVENTION

The field of the present invention relates generally to building materials and, in particular, to building materials having characteristics for withstanding high velocity storms and earthquakes.

In the news recently were reports of as-yet unrepaired damage to broad sections of New Orleans caused by Hurricane Katrina, a storm that occurred a decade ago. Houses and commercial buildings built using known construction materials and methods were heavily damaged by the wind and flooding of that storm, many of which were damaged beyond repair. Had materials used for New Orleans' buildings and housing had the strength to remain standing with roofs intact under such winds and water, then the news from New Orleans 10 years after the storm would have been far more positive. New Orleans is indeed a city that is justifiably proud to have weathered Katrina. Had the materials used for her buildings and housing had the strength and water-resistant characteristics to protect them from high winds and water, even more the extreme shaking of an earthquake as well, then, New Orleans pride would have included being completely restored from the hurricane damage long before 10-year commemoration news reports were written.

What is needed is a building material usefully employed for new construction or refitting of existing structures that is capable of resisting the high winds of a Katrina as well as the surging water that resulted from that storm. The invention presented herein below is a panel having such strength and water-resistance.

### SUMMARY OF THE INVENTION

One embodiment provides a panel that includes (a) a first material having an inside surface and an outside surface, (b) a second material having an inside surface and an outside surface, and (c) a zig-zag web with arms and apices disposed between the first material and the second material, wherein the outside surfaces of the first material and the second material are each substantially planar and parallel to one another, the inside surfaces of the first material and the second material contact the apices.

In another embodiment, the apices are V-shaped or U-shaped or flat.

In another embodiment, the apices are attached to the inside surfaces of the first material and the second material, respectively.

In another embodiment, the inventive panel further includes a void or insulation disposed between each pair of adjacent arms.

In another embodiment, the zig-zag web includes metal or plastic.

In another embodiment, the insulation is selected from the group consisting of a plastic, fiberglass, rock and slag wool, cellulose, natural fiber, vermiculite, perlite, papercrete, and foil.

In another embodiment, the plastic is a phenolic foam, a cementitious foam, a polyurethane, a polyisocyanurate, a urea-formaldehyde foam, a urea foam, a polystyrene, and a polyethylene foam.

In another embodiment, the insulation is in the form of a triangular tube.

In another embodiment, (i) the insulation includes a multiplicity of triangular tubes, wherein further adjacent triangular tubes, (ii) are disposed in parallel, and (iii) have opposing orientations. By doing so, the multiplicity of triangular tubes form two substantially parallel and planar outer surfaces.

In another embodiment, the panel further includes an adhesive.

In another embodiment, the adjacent triangular tubes are attached to one another or opposing sides of an arm of the zig-zag web or the inside surfaces of the first material and the second material, respectively.

In another embodiment, the adhesive is applied to substantially all adjacent surfaces of the panel.

In another embodiment, the adhesive is applied to substantially all adjacent surfaces of the panel prior to assembly.

In another embodiment, upon setting, the adhesive forms a truss.

In another embodiment, the adhesive is selected from the group consisting of epoxies, urethanes, methacrylates, polystyrenes, acrylics, ceramics, silicones, cyanoacrylates, neoprenes, and nitriles.

In another embodiment, the adhesive is a composite comprising particulate matter.

In another embodiment, the particulate matter is selected from the group consisting of stone, cement, plastic, ceramic, and glass.

In another embodiment, the external material or the internal material is selected from the group consisting of a foam, plaster, drywall, steel, diamond-tread aluminum, plywood, chipboard, an oriented strand board, acrylic, hardboard, a plastic, a carbon fiber and epoxy composite.

In another embodiment, the outside surface of the external material is selected from the group consisting of steel, diamond-tread aluminum, acrylic, a plastic, a carbon fiber and epoxy composite, a sprayable cement, and gypsum board.

In another embodiment, the panel further includes a composite formed of at least an adhesive and particulate matter, wherein the composite is disposed on the inside surface of the external material or the internal material.

In another embodiment, the composite is disposed on a longitudinal surface of a triangular tube.

In another embodiment, a longitudinal surface of a triangular tube is in contact with an adjacent triangular tube or an inside surface of the external material or the internal material.

In another embodiment, the insulation is a triangular tube that is formed of a material selected from the group consisting of fiberglass, rock and slag wool, cellulose, natural fiber, cementitious or phenolic foam, vermiculite, perlite, and a polymer.

In another embodiment, the triangular tube is formed of cementitious or phenolic foam.

In another embodiment, the present invention relates to a building material that includes (a) an external material having an inside surface and an outside surface, (b) an internal material having an inside surface and an outside surface, (c) a zig-zag web with arms and apices disposed between the external material and the internal material and voids between adjacent arms, (d) insulation disposed in one or more voids, (e) a composite material comprising an adhesive and particulate material, wherein the composite material is applied to (i) inside surfaces of the external material and the internal material, (ii) the zig-zag web, and (iii) the insulation; and wherein the outside surfaces of the external material and the internal material are each substantially planar and parallel to one another, the inside surfaces of the external material and the internal material contact the apices.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The n'ovel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a cross-section drawing of the inventive panel illustrating an interior zig-zag web.

FIG. 2 shows a cross-section drawing of one embodiment of the present invention, illustrating triangular tubes connected by an adhesive material, which adhesive material, in one embodiment, connects the triangular tubes to the zig-zag web; in a second embodiment, the adhesive material fixes in place the triangular tubes and, at the same time, forms the zig-zag web.

FIG. 3 shows an enlarged portion of FIG. 2, illustrating the continuous connections between the adhesive material that attaches one triangular tube to another (or each adjoining pair of triangular tubes to the zig-zag web).

FIG. 4 is a perspective view of the inventive panel shown in FIG. 1.

FIG. 5 is a perspective view of the inventive panel shown in FIG. 2.

FIG. 6 is a cross-section view of one embodiment of the interior zig-zag web, namely a rib web.

FIG. 7 is a cross-section view of another embodiment of the interior zig-zag web, namely a V-shaped web.

FIG. 8 is a cross-section view of another embodiment of the interior zig-zag web, namely a corrugated or U-shaped web.

FIG. 9 is a cross-section view of another embodiment of the interior zig-zag web, namely a second corrugated or U-shaped web.

### DETAILED DESCRIPTION OF THE INVENTION

In one example, the present invention relates to a panel having characteristics of high strength to wind or projectiles or shaking as well as a high level of water resistance. It is intended that the inventive panels be used in place of the entirety of a wall or roof or floor. For example, an exterior wall of a house includes interior and exterior facades attached to a frame. The frame is comprised of wood studs regularly placed along the length of the wall. The prior art interior facade, today, is commonly composed of drywall or the like, i.e., an interior planar surface, secured to the studs of the frame. One typically applies paint or wall paper or wood paneling to the interior planar surface. The prior art exterior facade is typically formed by a sheathing (usually plywood) attached to the frame's studs and, covering the sheathing, is brick, stone, stucco, or siding. Between the interior and exterior facades of the outside wall, at least in well-constructed structures, is an insulating material, which commonly is fiberglass batts or a plastic that is blown into the interior voids of the wall, i.e., between the wall studs. All three portions of the exterior wall are preferably replaced by a panel of the present invention, which provides superior strength, superior insulation, and superior protection from precipitation of any form; and, further, has decorating-ready facade surfaces on the interior and exterior planar surfaces.

For example, the inventive panel, in one embodiment, provides an exterior surface (i.e., the surface that faces the outside environment on outside panels) that resists damage from projectiles, wind, or water. It also provides an interior surface (i.e., the surface that faces the inside environment) that can be painted or otherwise decorated. Lastly, the portion of the inventive panel between the exterior and interior surfaces includes a structure that acts as a truss and affords the panel extraordinary strength with flexibility for resisting forces that otherwise might push or pull the outer wall to a breaking point. For panels usefully employed for interior walls of a structure, i.e., wherein both sides of the panel face the inside environment, in most embodiments of the invention, it is generally the case that both sides of the panel have interior surfaces ready for decoration.

Overall, one embodiment of the inventive panel comprises an exterior surface that is not only water-resistant but also substantially impervious to projectiles that may crash into a house, as may occur during a storm that includes high velocity winds or, in extreme circumstances, gunfire. This inventive panel further comprises an interior surface that, as manufactured, can be used as is or can be painted, wall papered, or otherwise further finished per a user's tastes. The source of insulation and flexible strength lies between the interior and exterior surfaces where insulating material resides in the voids created by a zig-zag web. It is the zig-zag web that provides the flexible strength as its structure when attached at each apex to the inside surfaces of the interior and exterior facades forms a standard truss. With attachment of the apices of the zig-zag web attached to the inside surfaces of the interior/exterior surfaces, the inventive panel becomes a monolithic structure. It is the monolithic nature of the inventive panel that heightens the inherent flex and strength characteristics provided by the truss structure of the zig-zag web.

The thickness of the inventive panel varies with different embodiments thereof. For example, for inventive panels usefully employed as walls, i.e., employed with the broad planar surfaces in a vertical position, the typical range of thickness from outside planar surface to outside planar surface is from about two inches to about 24 inches. In other embodiments, the range of thicknesses can be from about three inches to about eight inches. In yet other embodiments, the range of thicknesses can be from about five inches to about six inches. As it happens, thicknesses can be dictated by pre-existing structures and the thicknesses of walls there. Older homes, for example, have walls built with standard two by four inch studs. Current tornado-resistant designs, on the other hand, commonly have walls between about five inches and about six inches.

Panels of the present invention usefully employed for a roof can have a range of thicknesses between about three inches and about 48 inches; preferably, the range of thicknesses of roof panels of the present invention is from about four inches to about 24 inches; and yet more preferably, the range is from about 10 inches to about 14 inches; and even more preferably, the roof panel of the present invention is about 12 inches thick.

Panels of the present invention usefully employed for a floor can have a range of thicknesses between about five inches and about 24 inches; preferably, the range of thicknesses of floor panels of the present invention is from about five inches to about 12 inches; and yet more preferably, the range is from about 11 inches to about 13 inches; and even more preferably, the floor panel of the present invention is about 12 inches thick, plus or minus a half inch.

Panels of the present invention usefully employed for a door can have a range of thicknesses between about one inch and about eight inches; preferably, the range of thicknesses of door panels of the present invention is from about one inch to about six inches; and yet more preferably, the range is from about two inches to about six inches; and even more preferably, the floor panel of the present invention is about two inches thick, plus or minus five-eighths of an inch.

Panels of the present invention usefully employed for a garage door can have a range of thicknesses between about four inches and about 18 inches; preferably, the range of thicknesses of garage door panels of the present invention is from about four inches to about 12 inches; and yet more preferably, the range is from about four inches to about eight inches; and even more preferably, the floor panel of the present invention is about six inches thick, plus or minus an inch.

Materials usefully employed for the planar materials that sandwich the internal webs of the present invention include, for example, carbon fiber with epoxy (i.e., a high strength fiberglass). Alternative materials include a flexural material for the web, i.e., the truss element of the inventive panel, and a stiffer material for the outside covering, i.e., the planar surface. A stiffer material for this purpose are bullet-resistant, such as a bullet resistant plaster that can be pumped or sprayed. One bullet resistant plaster is sold under the tradename Ballisticrete®. Other useful planar materials include, for example, steel plating starting from about 16 gauge to about 3 gauge; more preferably from about 12 gauge to about 4 gauge; yet more preferably from about 10 gauge to about 5 gauge. Another usefully employed material for the planar surfaces of the present invention is a pourable waterproof material having a fire rating. for example, a sprayable concrete material sprayed onto a fiberglass planar material is a good material for the present invention. One such product is sold under the tradename Gunnite®.

Floor panels manufactured in the context of the present invention can usefully employ cement board or exterior grade gypsum board for the planar material. Other suitable planar materials include any sheet to which is applied sprayed concrete, for example.

Aspects of the present invention may be better understood in reference to the Figures. As used herein, “inside” refers to the interior of the panel irrespective of which planar surface is referenced; and “outside” refers to the exterior of the planar surfaces. Also, the outside surface of the exterior planar surface is referred to here as the “exterior facade” and, analogously, the outside surface of the interior planar surface is referred to as the “interior facade.”

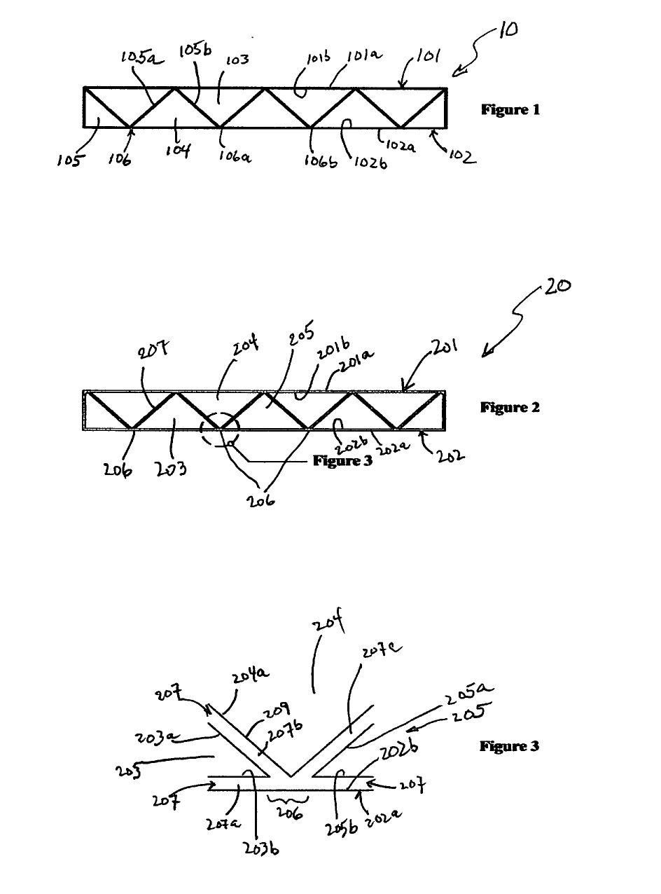

The invention employed in one embodiment is illustrated in FIG. 1. There, the panel 10 comprises an external material 101 that has an outside surface 101a and an inside surface 101b. The panel 10 also comprises an internal material 102 that comprises an outside surface 102a and an inside surface 102b.

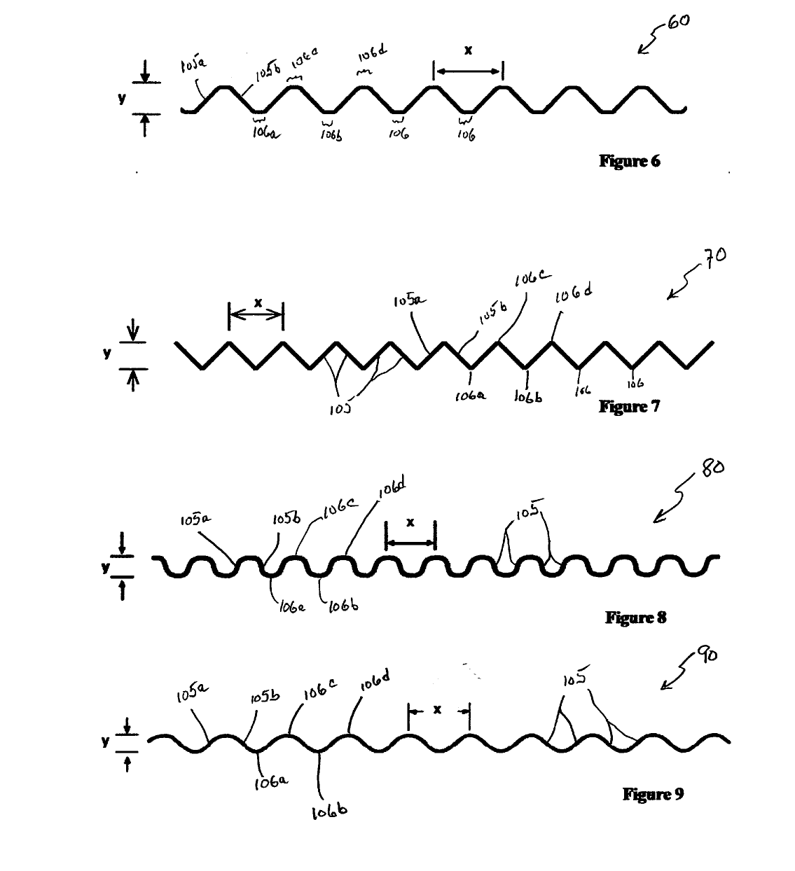

The structure of the interior of the inventive panel 10 includes a zig-zag web comprised of apices 106, where apex pairs 106a, 106b and 106c, 106d are “adjacent apices” and apex pairs 106a-106c, 106b-106c, and 106b-106d are “opposite apices.” The apices can vary in different embodiments of the invention. For example, the apices can be pointed (as in V-shaped webs illustrated by panel 10 of FIG. 1) or curvilinear (as in U-shaped or corrugated webs illustrated by webs 80 and 90 of FIGS. 8 and 9, respectively). The apices can also be flattened, thereby increasing surface contact at the apices between the web and the inside surfaces of the planar surfaces of the panel (as in “rib” webs illustrated by web 60 of FIG. 6).

Connecting opposite apices are arms 105, where arm 105a and arm 105b are “adjacent arms.” The space between adjacent arms are referred to as “voids,” such as void 103 and void 104. With the V-shaped apices shown in FIGS. 1 and 2, the voids are substantially triangular in shape such that they can be filled using insulation formed into triangular tubes, for example, one comprised of polystyrene or batts of fiberglass, among many other insulating materials well-known to practitioners of the construction arts. In the alternative, insulation can be introduced to the voids using a flowable insulation material, such as, for example, a spray foam insulation comprised of, as just one example, a urea formaldehyde based on the family of amine/furan resins consisting of phenol, urea and melamine, coupled with an aldehyde. See Alex Wilson, Formaldehyde-Based Foam Insulation Back From The Dead, 2013, Building Green Energy Solutions Blog, https://www2.buildinggreen.com/blogs/formaldehyde-based-foam-insulation-back-dead. Artisans in the field of insulation chemistry can readily select suitable insulation materials that can be placed and/or flowed into place in the voids 103, 104 included in the inventive panels. One can also reasonably rely on experts associated with companies that specialize in insulating materials as well as insulation trade associations, such as, for example, North American Insulation Manufacturers Association (NAIMA, www.naima.org), National Insulation Association (www.insulation.org), Polyisocyanurate Insulation Manufacturers Association (PIMA, www.polyiso.org), CertainTeed Corp. (www.certainteed.com), Johns Manville (www.jm.com), Owens Corning (www.owenscorning.com), Knauf Insulation (www.knaufinsulation.us), among many others.

Arms on V-shaped webs (e.g., web 70 or web 60, respectively) are straight and thus exhibit lesser flexibility in transferring received force relative to arms on U-shaped or corrugated webs (e.g., webs 80 or 90). With U-shaped apices, the attached arms generally have a curvilinear aspect that increases the ability of the arms to flex in response to a received force and may contribute to a greater capacity to dissipate the received force. The rib webs, i.e., web 60, for example, like V-shaped webs, also have straight arms, exhibit lesser flexibility in transferring received force thus delivering received force to the apex distal from the direction from which the force came.

Triangular tubes could still be used to deliver insulation to the voids of rib web-containing panels, however the void area would likely be inefficiently filled in view of the flat portion of the central apex of each void. Similarly, the voids of corrugated or U-shaped web-containing panels would also be inefficiently filled by triangular tubes, owing to the curvilinear aspect of its apices. Accordingly, when U-shaped apices are employed, it is preferred to use a flowable insulation material to fill the voids. Alternatively, one could instead opt for a malleable (i.e., stuffable) insulation material, such as a fiberglass batt, appropriately sized.

Arms 105 as shown in the embodiment of FIG. 1 can be made of any material having suitable strength and flexibility characteristics for adjustment to forces applied against the panel's exterior facade 101a. Artisans of building materials will readily apprehend such suitable materials, which include, without limitation intended, steel, aluminum, alloys of iron or aluminum, a carbon fiber—epoxy composite, and a plastic such as polyvinylchloride, polyethylene, and the like. Attachment of the apices to the inside planar surfaces (e.g., inside planar surfaces 101b and 102b of the inventive panel 10) is accomplished using any suitable connecting means. Suitable connecting means include, without limitation intended, an adhesive, a solvent for materials usefully employed for the inside surface(s) and web which materials dissolve in the presence of said solvent and thereby fuse one to the other. Useful solvent-fused materials in the context of the present invention include, for example, a polyvinylchloride, which can be “welded” by the purposeful application of aromatic hydrocarbons, ketones, and cyclic ethers, such as cyclohexanone, tetrahydrofuran, methylethylketone (MEK), and the like.

Apices and the inside planar surfaces can also be attached by fiberglassing the web to the inside planar surfaces using a combination of polyester resin, catalyst (or hardener), and fiberglass fibers. Bundles of fiberglass, commonly in the form of a mat-like material, are distributed over the web and inside planar surfaces. For example, strips can be cut from the fiberglass mat that have a suitable width to cover the apices of the web; and the inside planar surface can also be covered with commensurate width strips of fiberglass mat at intervals that are substantially spaced and positioned relative to the apices of the web (or the entire inside planar surface is covered with a fiberglass mat). With the mat placed against the inside planar surface followed by application of the polyester resin to which has been added an appropriate proportion of catalyst (which proportion is specific to the concentrations included of these two components); and immediately thereafter or concurrently the mat strips positioned on the apices of one side of the web are also treated with the polyester resin—catalyst mixture; after which the inside planar surface is laid onto the fiberglassed apices of the web until the fiberglass sets. Once the apices of one side of the web has attached to the inside planar surface via the fiberglassing treatment, then the identical procedure is performed on the opposing side of the web and a second inside planar surface. Upon the second inside planar surface being fixed to the opposing side of the web, the panel of the present invention is formed. Other embodiments include the addition of insulating materials into the voids located between adjacent pairs of web arms (e.g., in FIG. 1, void 104 is located between web arms 105a and 105b). The addition of insulating materials is accomplished using standard methods and materials well-known in the construction arts. Thereafter, with or without the addition of insulating material, for yet another embodiment of the present invention, one can lend yet more stability to this now monolithic structure by adding a layer of fiberglass to the outside planar surfaces in a continuous manner such that the large planar surfaces and the edges that separate the large planar surfaces are covered in a continuous layer of fiberglass. the method of fiberglassing is as described above except that the fiberglass mats are commonly from a large roll of that material.

Fiberglassing kits are available from many construction supplies outlets, including, literally, any hardware store. For general supply of all components for fiberglassing, see, e.g., www.fiberglasssupply.com or any Ace Hardware or Home Depot or the like. The polyester resin and catalyst (or hardener) are provided separately and must be mixed prior to use. The mixture is stirred thoroughly using a paint stick or some other suitable, non-reactive material. The mixed poly resin—catalyst mixture is then liberally applied to the fiberglass mat, which then attaches to the web and one inside planar surface. Subsequently, a second fiberglass mat is applied to the other side of the web and the second inside planar surface; and, again, the poly resin—catalyst mixture is liberally applied causing the web to become fixed to both inside planar surfaces where the apices contact said surfaces. In this manner, the two planar materials and the web form a single unit. The strength of the inventive panel is derived from the monolithic nature of the attached planar materials that forms a sandwich of the web fixed there between.

In particular, broadening the methods of attachment and referring to FIG. 1, the apices 106 are attached to the inside surfaces of the first material 101 (also referred to herein as a first planar surface) and the second material 102 (also referred to herein as second planar surface. Suitable means of attachment include, without limitation intended, fasteners, welds, adhesives, and the like. For example, one can attach the web to the inside plaar surface using a suitable glue that has characteristics for attacking a fiberglass surface, when using a fiberglass web and a fiberglass planar surface. When the zig-zag web and the inside surfaces of the first and second materials are formed of a plastic for which a solvent is available, solvent-based “welding” of the apices to the inside surfaces is a particularly time-efficient method for joining the zig-zag web to the external/internal materials. In addition or in the alternative, any of various methods of attachment using fiberglass plus a poly resin—catalyst mixture as known in the art can be usefully employed for forming the

The voids 103, 104 and the like can be filled with insulation. Suitable insulation employed in the context of the present invention include board, batt, and flowable varieties so long as the insulation fits in and is deliverable to the voids. Insulation materials can be selected from the group consisting of a plastic, fiberglass, rock and slag wool, cellulose, natural fiber, vermiculite, perlite, papercrete, and foil; and combinations thereof. Indeed, any of the alternatives are particularly useful in combination with the reflective characteristics of foil. Suitable plastic insulation can be selected from the group consisting of a phenolic foam, a cementitious foam, a polyurethane, a polyisocyanurate, a urea-formaldehyde foam, a urea foam, a polystyrene, and a polyethylene foam.

The structure of FIG. 1 uses a zig-zag web that is V-shaped. The V-shaped web 70 is shown by itself in FIG. 7, wherein arms 105, 105a, and 105b are labeled as are apices 106 and 106a-d. One forms the inventive panel in the V-shaped web embodiment by attachment of a flat external material (not shown) on one side and a flat internal material (not shown) on the other side such that the apices in contact with the inside surface of one flat material, say the flat external material, become attached thereto and the apices in contact with the inside surface of the other flat material, say the flat internal material, become attached there. The attachment methods set forth above are precisely how one converts this three component panel into a monolithic structure of three components that acts as if a single unit.

The pitch of the zig-zag web increases as the distance occupied between adjacent apices decreases; as indicated on FIG. 7, the distance between adjacent apices is defined as distance x. The pitch is more fully described in the context of one more parameter, namely the depth of the web, which is the distance occupied between the parallel planes defined by the two sets of opposing apices, where one plane is defined by points defined by apices 106c and 106d and the other plane is defined by points defined by apices 106a and 106b. The two described planes are separated by the distance y. For a given depth of distance y, the pitch is greater as the distance between adjacent apices narrows. Conversely, for a given distance between adjacent apices, the pitch increases as the distance between the parallel planes increases.

For the inventive panel, the distance between the parallel planes relates to its thickness. The greater distance between the parallel planes, the thicker the inventive panel will be. Further, the increasing distance between the parallel planes lends a greater potential R value as the voids will occupy greater volume in which more insulating material can be introduced. (The R value is a standard measurement of insulating capacity of a wall, as generally known in the construction arts.) Panels where the distance y is between about 1 inch and about 15 inches are usefully employed for different embodiments of the present invention; more particularly, inventive panels of various embodiments include a distance y that is about 2 inches, about 3 inches, about 4 inches, about 5 inches, about 6 inches, about 7 inches, about 8 inches, about 9 inches, about 10 inches, about 11 inches, about 12 inches, about 13 inches, about 14 inches or about 15 inches are used for scenarios requiring greater or lesser insulating capacity as well as greater or lesser force-bearing capacity. For example, a first-floor outside wall for a three story building in Fairbanks, Ak. would call for a thicker exterior panel both for the added stress of withstanding the force exerted by two floors above the first floor as well as added insulating capacity of the larger void volume for maximizing the insulating material for holding off the extreme and extended cold of an Alaskan winter. In one embodiment, such an Alaskan building can require the distance y to be between about 8 inches thick to about 15 inches thick; in another embodiment, this Alaskan building can require the distance y to be between about 10 inches thick to about 15 inches thick; and in yet another embodiment, this Alaskan building can require the distance y to be between about 12 inches thick to about 15 inches thick.

In contrast, a single-floor tiny house located in New Mexico may be well served using exterior walls that are substantially narrower, where the distance y is between about 2 inches to about 8 inches. Of course, the first floor walls of a tiny house have only a roof to support and sand storms, seasonal rains and seasonal heat to withstand. Accordingly, the issue of what is an appropriate thickness of the zig-zag web may be usefully determined by the efficiency of the contained insulating material. In one embodiment, the distance y is between about 3 inches and about 8 inches; in another embodiment, the distance y is between about 4 inches and about 8 inches; and in yet another embodiment, the distance y is between about 5 inches and about 7 inches.

Where the weather tends to be more violent, as in tornado season in Kansas or Oklahoma, among other such geographies, the variable of greater concern can be the number of apices per unit length. The greater number of attachment points per unit length between apices and the inside surfaces of the internal and external planar materials, the stronger the inventive panel is likely to resist damage due to high wind or, worse, projectiles launched by high wind as commonly occurs in Tornado Alley. Accordingly, in one embodiment of inventive panels for employment in structures in Tornado Alley, the distance x in a panel 10 is between about 5 inches and about 12 inches; between about 5 inches and about 10 inches; between about 5 inches and about 10 inches.

The very same considerations are addressed irrespective of the profile of the zig-zag web that is employed for a particular inventive panel. Corrugated (also referred to as U-shaped) webs 80 or 90 as well as rib webs 60 are appropriately altered with regard to distance y regarding concerns of insulation capacity primarily and overall strength secondarily; and with regard to distance x regarding concerns of overall strength primarily for withstanding the extraordinary wind forces of Tornado Alley or a Florida hurricane season. In all cases, in the same manner is described above for the V-shaped web, the construction engineer will select inventive panels having the considered insulating capacity and/or strength capacity to meet the likely challenges of the locality where the structure is located.

One additional comment is appropriately lodged for the rib web 60 design. Because the rib web 60 maximizes contact area between the apices and the inside surfaces of the external and internal planar surfaces, it is a preferred embodiment for environments challenged with heavy weather and/or earthquakes. That additional surface area of contact between apex and inside planar surface can lend significantly added strength at those attachment sites such that the internal truss structure of the inventive panel can be maintained under the extreme conditions of wind force, projectile collisions, and/or earthquake.

Referring now to FIG. 2, this figure describes another embodiment of the present invention. Overall, the structure 20 is the same as the embodiment illustrated in FIG. 1. The difference in large measure is that (1) the insulation employed has a retained shape of a substantially triangular tube and (2) the zig-zag web is formed in situ by the adhesive used to bind the triangular tubes to each other and to the inside surfaces of the planar external/internal materials. The use of substantially solid insulators lends an additional modicum of stability and strength to the inventive panel, in particular for increasing capacity of the panel for load bearing.

Again referring to FIG. 2, the broad stroke description of this embodiment can be more particularly set forth. Similar to the preceding FIG. 1, the panel 20 has an external material 201 and an internal material 202, each of which have inside surfaces 201a, 202a and outside surfaces (not shown), respectively. Instead of voids, the panel 20 includes triangular tubes 203, 204, 205 that are joined to each other as well as to the inside surfaces of the interior/exterior planar materials. The joining of these materials is generally accomplished using an adhesive, more particularly, using an adhesive-particulate matter composite. Suitable composites include, without limitation intended, a carbon fiber and epoxy composite.

FIG. 3 is an expanded view of the joined materials at an apex 206. This apex is used here to illustrate the joining of insulating triangular tube 203 to insulating triangular tube 204 and insulating triangular tube 204 to 205, using adhesive 207. In particular, adhesive located at positions 207b and 207c serve to join the two pairs of tubes to each other. The tubes are also glued to the inside surface of the interior material using adhesive located at positions 207a and 207d.

It is understood that the figures depict generalized structures of certain embodiments of the present invention. The figures are not limiting. For example, FIG. 1 does not limit the inventive panel to V-shaped zig-zag webs. U-shaped zig-zag webs have also been described and, as shown in FIGS. 8 and 9, the distance x between apices can be shortened, as in web 80, resulting in an inventive panel of greater strength than that of web 90 where the distance x is longer resulting in fewer points of contact and attachment between the web and the inside surfaces of the internal/external planar materials. One can also perceive in the various web examples depicted that increasing the distance y between the parallel planes defined by the two sets of adjacent apices of each web results in a thicker wall that will have greater load-bearing capacity as distance y increases. As well, such thicker walls (or panels) has a greater potential for insulation capacity. However, as depicted by FIG. 2, no limit is described regarding the characteristics of the particular sort of insulation material employed. Furthermore, there may be other features not necessarily depicted in the figures. The present invention is only limited by the claims.

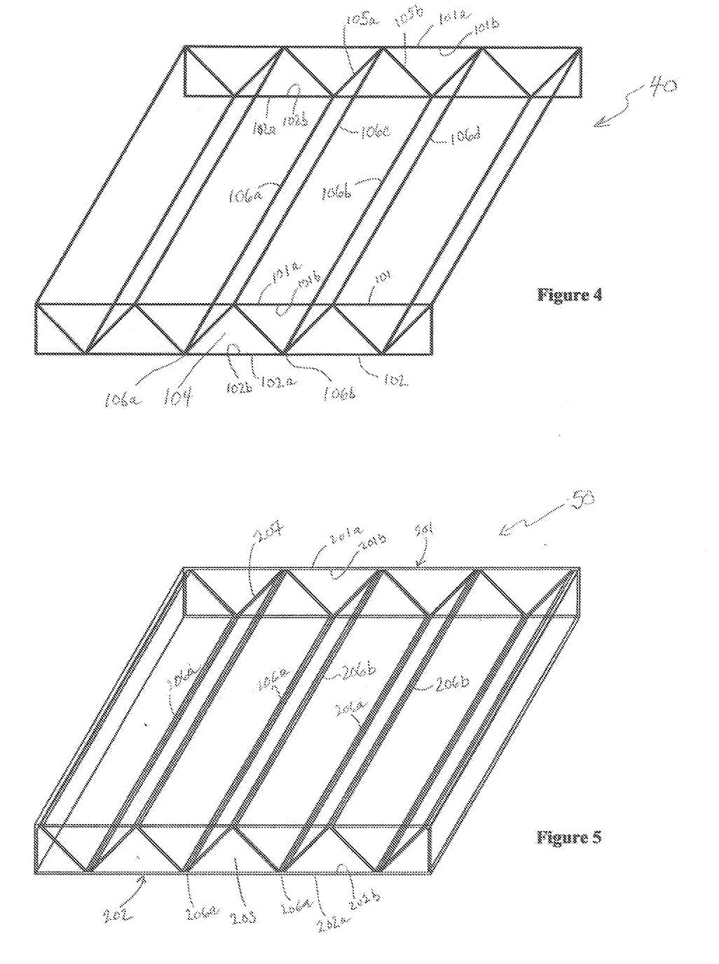

A perspective view of the panel of the present invention built in accord with the embodiment depicted in FIG. 1 is illustrated in FIG. 4. There, one can see adjacent apices 106c and 106d as well as opposite apices 106c and 106b, or 106d and 106b. The edges of the planar material is shown as in, for example, outside surface 101a and inside surface 101b; the full plane that reaches across the inventive panel contacting the entire length of, for example, apices 106c and 106d, is not shown. Similarly, the outside surface of the other planar material is shown where outside surface 102a and inside surface 102b are illustrated. The two planar materials 101 and 102 can be two internal planar materials as may be employed for internal walls of a building, one internal and one external planar materials as may be employed for external walls of a building, or two external planar materials as may be employed for a free-standing wall structure used as a break wind to help livestock withstand winter cold. The internal zig-zag web employed in panel 40 is there shown to be a V-shaped web. In other embodiments, the internal zig-zag web is a rib web 60; or a V-shaped web 70 having differing pitch and depth due to altered distances x and y; or a corrugated or U-shaped web 80 or 90 having differing distances x and y.

A perspective view of the panel of the present invention built in accord with the embodiment depicted in FIG. 2 is illustrated in FIG. 5. There, one can see apices 206a and 206b. The edges of the planar material is shown as in, for example, outside surface 201a and inside surface 201b; the full plane that reaches across the inventive panel contacting the entire length of, for example, apices 206b, is not shown apart from its edge 201. Similarly, the outside surface of the other planar material is shown where outside surface 202a and inside surface 202b are illustrated. The two planar materials 201 and 202 can be two internal planar materials as may be employed for internal walls of a building, one internal and one external planar materials as may be employed for external walls of a building, or two external planar materials as may be employed for a free-standing wall structure used as a break wind to help livestock withstand winter cold. The internal zig-zag web employed in panel 50 is there shown to be a V-shaped web. In other embodiments, the internal zig-zag web is a rib web 60; or a V-shaped web 70 having differing pitch and depth due to altered distances x and y; or a corrugated or U-shaped web 80 or 90 having differing distances x and y. In panel 50, the triangular tube 203 is an insulating material employed to create a panel with a particularly high R value, and where all surfaces of the triangular tubes and inside planar surfaces that are in contact are coated with an adhesive as described with reference to FIG. 2 and which forms the internal truss structure of the present invention.

While preferred embodiments of the present invention have been shown and described herein, it will be obvious to those skilled in the art that such embodiments are provided by way of example only. Numerous variations, changes, and substitutions will now occur to those skilled in the art without departing from the invention or the definitions provided herein for clearly recording inventor's conception and embodiments thereof. It should be understood that various alternatives to the embodiments of the invention described herein may be employed in practicing the invention.

It is intended that the following claims define the scope of the invention and that methods and structures within the scope of these claims and their equivalents be covered thereby.

What is claimed is:

1. A panel comprising (a) a first material having an inside surface and an outside surface, (b) a second material having an inside surface and an outside surface, and (c) a zig-zag web with arms and apices disposed between the first material and the second material, wherein the outside surfaces of the first material and the second material are each substantially planar and parallel to one another, and the inside surfaces of the first material and the second material contact the apices.

2. The panel of claim 1, wherein the apices are V-shaped or U-shaped or flat.

3. The panel of claim 2, wherein the apices are attached to the inside surfaces of the first material and the second material.

4. The panel of claim 3, further comprising a void or insulation disposed between each pair of adjacent arms.

5. The panel of claim 4, wherein insulation is disposed between one or more pairs of adjacent arms.

6. The panel of claim 1, wherein the zig-zag web comprises metal or plastic.

7. The panel of claim 5, wherein the insulation is selected from the group consisting of a plastic, fiberglass, rock and slag wool, cellulose, natural fiber, vermiculite, perlite, papercrete, and foil.

8. The panel of claim 7, wherein the plastic is a phenolic foam, a cementitious foam, a polyurethane, a polyisocyanurate, a urea-formaldehyde foam, a urea foam, a polystyrene, and a polyethylene foam.

9. The panel of claim 8, wherein the insulation is in the form of a triangular tube.

10. The panel of claim 9, wherein (i) the insulation comprises a multiplicity of triangular tubes, wherein further adjacent triangular tubes, (ii) are disposed in parallel, and (iii) have opposing orientations.

11. The panel of claim 1, further comprising an adhesive.

12. The panel of claim 11, wherein adjacent triangular tubes are attached to one another or the inside surfaces of the first material and the second material, respectively.

13. The panel of claim 12, wherein the adhesive is applied to substantially all adjacent surfaces of the panel.

14. The panel of claim 13, wherein, upon setting, the adhesive forms a truss.

15. The panel of claim 11, wherein the adhesive is selected from the group consisting of epoxies, urethanes, methacrylates, polystyrenes, acrylics, ceramics, silicones, cyanoacrylates, neoprenes, and nitriles.

16. The panel of claim 15, wherein the adhesive is a composite comprising particulate matter.

17. The panel of claim 16, wherein the particulate matter is selected from the group consisting of stone, cement, plastic, ceramic, and glass.

18. The panel of claim 1, wherein the first material or the second material is selected from the group consisting of a foam, plaster, drywall, steel, diamond-tread aluminum, plywood, chipboard, an oriented strand board, acrylic, hardboard, a plastic, a carbon fiber and epoxy composite.

19. The panel of claim 1, wherein the outside surface of the first material is selected from the group consisting of steel, diamond-tread aluminum, acrylic, a plastic, a carbon fiber and epoxy composite, a sprayable cement, and gypsum board.

20. The panel of claim 19, wherein the first material and the second material are the same or different and comprise an external surface or an internal surface.

21. The panel of claim 11, further comprising a composite formed of at least an adhesive and particulate matter, wherein the composite is disposed on the inside surface of the first material or the second material.

22. The panel of claim 21, wherein the composite is disposed on a longitudinal surface of a triangular tube.

23. The panel of claim 21, wherein a longitudinal surface of a triangular tube is in contact with an adjacent triangular tube or an inside surface of the first material or the second material.

24. The panel of claim 5, wherein the insulation is a triangular tube that is formed of a material selected from the group consisting of fiberglass, rock and slag wool, cellulose, natural fiber, cementitious or phenolic foam, vermiculite, perlite, and a polymer.

25. The panel of claim 24, wherein the triangular tube is formed of cementitious or phenolic foam.

26. A building material comprising (a) a first material having an inside surface and an outside surface, (b) a second material having an inside surface and an outside surface, (c) a zig-zag web with arms and apices disposed between the external material and the internal material, (d) insulation disposed between adjacent arms, (e) a composite material comprising an adhesive and particulate material, wherein the composite material is applied to (i) inside surfaces of the first material and the second material, (ii) the zig-zag web, and (iii) the insulation; and wherein the outside surfaces of the first material and the second material are each substantially planar and parallel to one another, the inside surfaces of the first material and the second material contact the apices, and the first material and the seond material are the same or different.
